(19) United States
(12) Patent Application Publication
(10) Pub. No.: US 2019/0043186 A1
(43) Pub. Date: Feb. 7, 2019

(54) OCCLUSIONLESS SCANNER FOR WORKPIECES

(71) Applicant: RAPTOR INTEGRATION INC., Canoe (CA)

(72) Inventors: Timothy Edward MOSHER, Canoe (CA); Darren Andrew ROSS, Canoe (CA); Thomas Jason HUGHES, Canoe (CA); Jeffrey Norman TEGART, Canoe (CA)

(21) Appl. No.: 16/053,094

(22) Filed: Aug. 2, 2018

Related U.S. Application Data
(60) Provisional application No. 62/540,861, filed on Aug. 3, 2017.

(30) Foreign Application Priority Data
Aug. 3, 2017 (CA) 2975159

(51) Int. Cl. G06T 7/00; H04N 5/247

(52) U.S. Cl. CPC G06T 7/0004; G06T 2207/30161; G06T 2207/30164; H04N 5/247

(57) ABSTRACT

A scanner system comprising a plurality of scanners which are spatially separated in both transverse and longitudinal directions relative to a workpiece flow in the longitudinal direction, the scanners adapted to produce corresponding scanned image data, a transport which moves workpieces in a workpiece flow, the transport including lateral curves in the transverse direction so the transport does not occlude a field of view of the scanners, wherein a first field of view of each scanner spatially separated in the longitudinal direction from a laterally adjacent scanner having a second field of view is adjacent to and abuts against the second field of view, so that the scanned image data produced by each scanner of the plurality of scanners abuts the scanned image data produced by the laterally adjacent scanner, whereby the scanned image data produced by each scanner of the plurality of scanners does not include overlapping image data.

### CROSS REFERENCE TO RELATED APPLICATIONS

This application claims priority from U.S. Provisional Patent Application No. 62/540,861 and Canadian Patent Application No. 2,975,159, both filed on Aug. 3, 2017, both entitled “OCCLUSIONLESS SCANNER FOR WORKPIECES”, entireties of which are incorporated herein by reference.

### FIELD

This invention relates to the field of scanners and in particular to a scanner for workpieces such as lumber workpieces wherein the scanner includes scanners arranged so as to collect comprehensive images of the workpiece and so as to avoid partial occlusion of the images by the workpiece transfers.

### BACKGROUND

As set out by Baker and Flatman in U.S. Pat. No. 7,751,612 which issued on Jul. 6, 2010, it is known in the prior art relating to scanners to scan workpieces such as flitches in a sawmill to detect defects such as a stain, shake, knots, etc. using so-called vision and profile scanners, and to map the profile of a workpiece including any wane edges. The results of such scanning are used to assist in optimizing further processing of the workpiece so as to recover the highest value and/or volume of pieces which may be cut from the workpiece.

Scanners for use in sawmills, planermills, logdecks, engineered wood product machine centres such as veneer scanning, panel scanning and the like, or in other wood applications, may scan either lineally, that is, sequentially along the length of the workpiece as the workpiece is translated longitudinally through the scanner, or transversely, that is, simultaneously along the length of the workpiece as the workpiece passes through the scanner, with the workpiece aligned transversely or laterally across the direction of flow of workpieces through the scanner. In the case of transverse scanning, conventionally, the workpieces are delivered on an infeed such as an infeed employing a spaced apart, parallel array of lugged transfer chains, smooth chains, belted transfers and the like, so as to pass each workpiece separately through a generally rectangular frame mounted laterally over and around the end of the infeed transfer. The scanner cameras and corresponding sources of illumination, such as halogen lamps or LED arrays, are typically mounted in the frame, often so as to simultaneously view both the top and bottom surfaces of the workpiece as the workpiece passes between the upper and lower beams or arms of the frame. Each camera has a pixel array aligned in a known orientation relative to the workpiece, for example aligned along the length of the workpiece. Light from the corresponding light sources is reflected from the surface of the workpiece and focussed by the camera lens onto the pixel array.

If the scanner is a profiling scanner, upper and lower triangulation geometry is used to arrive at a differential thickness measurement of the workpiece, derived from movement of the focussed light along the array of pixels in the upper and lower cameras, from which a profile of the workpiece is modelled by an associated processor as a wireframe profile image. The accuracy or resolution of the wireframe model is influenced by the scan density, that is, the number of cameras and associated light sources, each of which generate the profile of a cross-section of the workpiece; the more closely spaced are the cross-sections, the higher the scan density and the better the accuracy or resolution of the wireframe model of the workpiece. The wireframe model of the workpiece is used by an optimizer, that is, a processor running optimization software, to determine optimized downstream cutting solutions for optimized recovery from the workpiece.

If the scanner is a vision scanner, the cameras, rather than being used to generate workpiece profile measurements, provide color and/or contrast data from the workpiece exterior surfaces within the field of view of each camera as the workpiece translates through the scanner. The color and/or contrast data is processed to generate predictions of the type and location of visually detectable defects on the workpiece surfaces. Defects may include holes, splits, shake, pitch pockets, knots, bark or wane, stain, etc.

In so-called defect extraction, the type and location of defects on a workpiece are predicted by software based on data from one or more scanners. The data from vision and profiling scanners, or other forms of scanning, may be used in a complimentary fashion to aid in defect extraction. For example, profile information may aid in determining whether a dark spot on the surface of a board is a bark pocket, a smooth knot or a hole. Baker and Flatman describe mounting both vision scanners and profile scanners on a common frame so as to reduce cost and floor-space requirements, although separate frames may be employed. If scanning of a workpiece by both vision and profiling scanners may be done near simultaneously, then defect extraction is aided by minimizing the misalignment of the workpiece as it passes between the scanners so as to minimize misalignment of the vision and profile data and increasing the available data processing time before a cutting decision must be implemented by the programmable logic controllers (PLCs) instructing the actuators actuating the downstream cutting devices. In particular, and by way of example, the following methods of implementation may be employed: the optimizer may hand off control information to the PLC for actuation; or the optimizer processor may control discrete input/output for direct control of the actuators. Alternatively, the PLC may itself optimize and actuate the actuators.

As taught by Baker and Flatman, one of the problems with mounting both vision and profiling scanners in a common frame is interference between the two scanners. For example, if there is not a common light source for both scanners, and if the light source for one scanner is emitting light in a frequency which is within the detected frequency range of the other scanner, then the light source from the former scanner will interfere with the camera of the latter scanner. For example, in one known arrangement in a scanning machine the lines of laser light used as a light source by the profile scanning cameras extend in a parallel, spaced apart array in cross-sections over the workpiece along the length of the workpiece. The laser light used may be in the visible spectrum, for example red, or for example in the infra-red spectrum. Vision scanning cameras may therefore detect the reflected stripes of laser light across the workpiece depending on their spectrum, which may interfere with the vision scanning camera's processing of the broad spectrum of reflected light ordinarily impinging the pixel arrays in the vision scanning cameras, thereby leaving blind spots or stripes in the vision data mapping the surface of the workpiece.

Apart from any interference between the profile and vision scanner light sources affecting the vision scanner cameras, physical interference also occurs because the bottom view of the workpiece in the scanner, that is, the view looking upwardly at the lower surface of the workpiece is partially occluded by the parallel, spaced-apart, linear chainways known in the prior art, or other forms of transfers carrying the workpiece. One solution described by Baker and Flatman takes advantage of the lateral offset between the infeed and the outfeed transfers. Typically the infeed transfer translates the workpiece through the scanner frame, and immediately downstream of the scanner frame the infeed hands-off to the outfeed transfer. In order for there to be a smooth transition of the workpiece from the infeed to the outfeed, the adjacent ends of the infeed and outfeed are laterally offset from one another and may be staggered, for example in the case of chainways, so as to overlap in the downstream direction. Thus the workpiece is physically carried on the infeed transfer before being dropped from the end of the infeed transfer to assure a smooth transition.

This arrangement of the infeed transfer laterally offset onto the overlapping, upstream end of the outfeed transfer, so as to be staggered relative to the outfeed transfer, provides an opportunity to mount, for example, profile scanning cameras which are also laterally offset, along with corresponding lights, so as to minimize interference between profiling and vision scanners. Furthermore, the infeed and outfeed transfers are offset relative to one another in the upstream and downstream directions so as to remove interference between the linear chainways and the vision scanning of the lower surface of the workpiece.

Thus, Baker and Flatman describe an occlusionless scanner for sequentially scanning a series of workpieces translating in a downstream flow direction wherein the workpieces flow sequentially to the scanner on an infeed conveyor and sequentially from the scanner on an outfeed conveyor and across an interface between the infeed conveyors and the outfeed conveyors wherein scanner cameras are mounted so as to not interfere with one another nor to interfere with the conveyors to provide for the gathering of individual partial images of the workpiece by the individual scanner cameras, allowing a processor to assemble a collective image of the partial images and to remove from the collective image the transfer mechanisms, which occlude the overlapping fields of view of at least two of the scanners.

### SUMMARY

In the present disclosure, an occlusionless scanner system for scanning workpieces in a workpiece flow is provided in which the transports for urging the workpieces in the workpiece flow include lateral curves, such as S-bends, such that the transports in the infeed portion are laterally offset from the transports in the outfeed portion of the scanner system. The cameras or scanners in the infeed portion of the system may also be laterally offset from the scanners in the outfeed portion, with the field of view of the infeed and outfeed arrays of scanners being adjacent to and abutting against each other, and the fields of view may further be arranged such that they capture in-between the transports, such that when the scanners or cameras are recording or scanning the bottom surface of the workpieces, the image data captured does not include the transports occluding the bottom surface of the workpieces. Because the field of view of the scanners or cameras are adjacent to and abut against the field of view of the adjacent scanners or cameras, the image data captured by the arrays of scanners or cameras may be processed by a processor to combine the image data so as to produce a complete view of each workpiece, without occlusions caused by the transports and without having to remove portions of overlapping image data or portions of image data which include occlusions caused by the transports.

In an embodiment of the present disclosure, a scanner system comprising a plurality of scanners cooperating with a corresponding plurality of radiation sources which collectively are spatially separated in both a transverse and a longitudinal direction relative to a workpiece flow in said longitudinal direction, wherein said plurality of scanners have substantially separate, non-overlapping fields of view and wherein said plurality of scanners produce corresponding scanned image data for processing by image processing software, wherein a workpiece transport which moves workpieces in said workpiece flow includes lateral curves in said transverse direction so that said workpiece transport does not substantially occlude the fields of view, whereby the spatial separation renders unnecessary substantially any removal by the image processing software of portions of the image data which include images of the transport mechanisms which interfere with unobstructed images of workpieces carried in the flow direction by the transport mechanisms.

In other embodiments, a scanner system for scanning workpieces comprises a plurality of scanners cooperating with a corresponding plurality of radiation sources which collectively are spatially separated in both a transverse and a longitudinal direction relative to a workpiece flow in the longitudinal direction, the plurality of scanners adapted to produce corresponding scanned image data for processing by image processing software, a transport which moves the workpieces in the workpiece flow, the transport including lateral curves in the transverse direction so that the workpiece transport does not occlude a field of view of a scanner of the plurality of scanners, wherein a first field of view of each scanner spatially separated in the longitudinal direction from a laterally adjacent scanner having a second field of view is adjacent to and abuts against the second field of view, so that the scanned image data produced by each scanner of the plurality of scanners abuts the scanned image data produced by the laterally adjacent scanner, whereby the scanned image data produced by each scanner of the plurality of scanners does not include overlapping image data.

In other embodiments, a scanner system to sequentially scan a series of workpieces translating in a downstream flow direction sequentially to a first scanner scanning a first scanning zone on an infeed portion of a continuous conveyor and then to a second scanner scanning a second scanning zone on an outfeed portion of the continuous conveyor, the first and second scanning zones extending longitudinally across the infeed and outfeed portions of the continuous conveyor, wherein the infeed portion and first scanning zone is laterally offset from the outfeed portion and second scanning zone relative to the downstream flow direction of the workpieces, and wherein each scanner of the first and second scanners have corresponding first and second fields view, wherein in the second scanning zone, a downstream end of the infeed portion is laterally offset relative to an upstream end of the outfeed portion so as to thereby avoid an overlap between the first and second fields of view.

### BRIEF DESCRIPTION OF THE DRAWINGS

FIG. 1 is, in plan view, a laterally spaced apart array of S-bend chainways within a scanner frame supporting laterally spaced first and second staggered arrays of scanners for scanning workpieces carried on the chainways.

FIG. 2 is a cross-sectional view of the system of FIG. 1 taken along line 2-2.

### DETAILED DESCRIPTION

It is understood that the description of the background, described above, is not intended to limit the scope or ambit afforded the claims directed to the present invention as the background description merely reflects applicant's understanding of the present state of the art of wood processing. For example, the present invention is not intended to be restricted to either only vision scanning, profiling scanning, tracheid effect scanning or a combination of these, whether separate or in a single device or scanning package, as the present invention is intended to also include other forms of scanning such as multi-spectral, x-ray, microwave, etc.

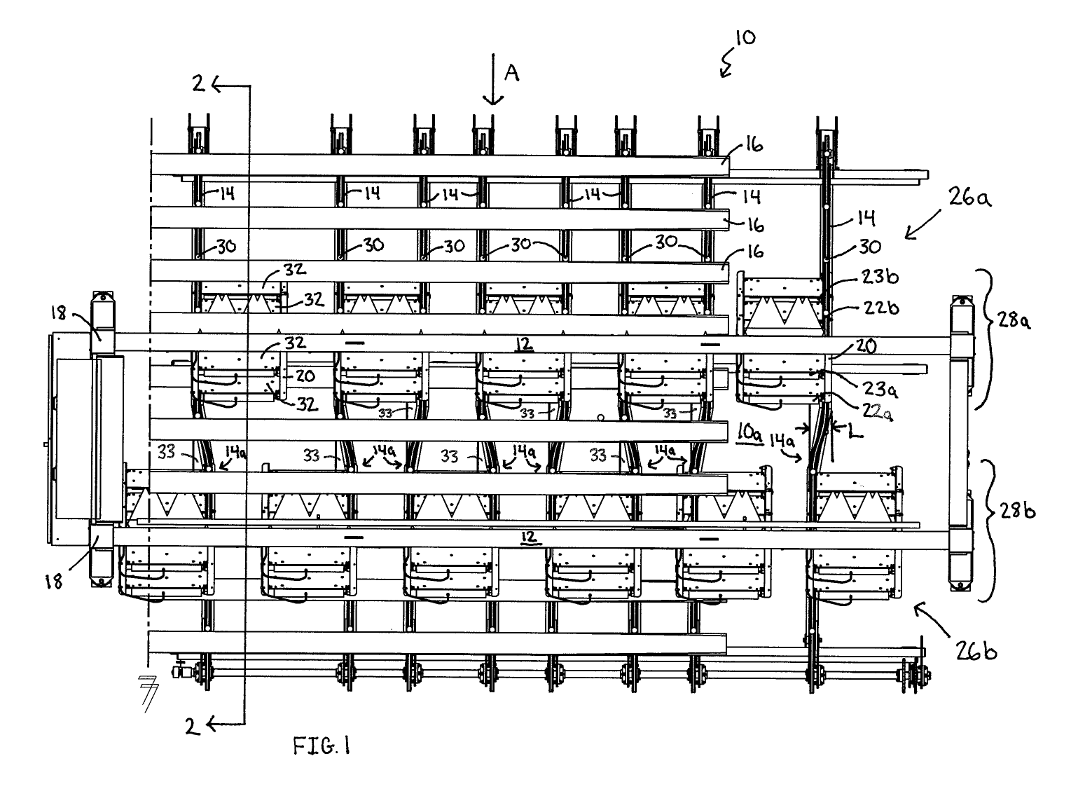

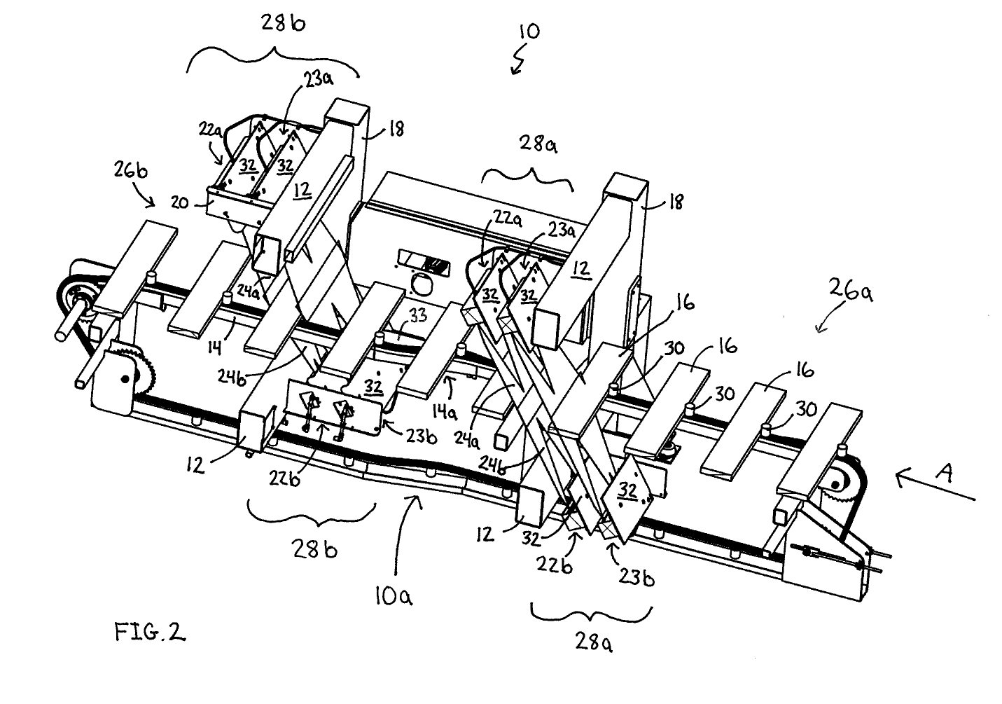

As seen in FIGS. 1 and 2, wherein like reference numerals denote corresponding parts in each view, a scanner frame 10 includes upper and lower beams 12 which extend laterally across, respectively over and under, offsetting S-curved continuous chainways 14 conveying lumber workpieces 16 in flow direction A. Beams 12 are supported at their ends by end columns 18. It will be appreciated by a person skilled in the art that the transport mechanism for transporting the workpieces need not be limited to the chainways 14 illustrated in FIGS. 1 and 2, and that any type of workpiece transport which includes an S-curve or other type of lateral curve, lateral relative to the workpiece flow, such as for example any type of continuous conveyor mechanism, may also work and is intended to be included in the scope of the present disclosure.

Rigid mounting brackets 20 are rigidly mounted to beams 12 so as to support upper profile camera 22a and lower profile camera 22b oriented to scan the scanning zone 10a defined by frame 10. Workpiece 16 translates in direction A on chainway 14 between the upper and lower profile cameras 22a, 22b so that the upper profile cameras 22a scan the upper surface profile of workpiece 16 and the lower profile cameras 22b scan the lower surface profile of workpiece 16.

Upper and lower vision cameras 23a, 23b may also be either rigidly mounted to frame 10 or rigidly mounted adjacent to frame 10. They may be mounted immediately downstream of frame 10 or they may also be located upstream of the profile scanners, or alternated upstream and downstream of the profile scanners or cameras (interchangeably referred to herein as scanners or cameras). The lower vision cameras 23b, that is, the vision cameras scanning the lower surface of workpiece 16, may advantageously be laterally offset from one another. Each of the vision cameras 23a, 23b and profile scanners 22a, 22b include corresponding radiation sources, such as lights, the radiation sources directing radiation to the surface of a workpiece 16, and corresponding sensor arrays for sensing the radiation reflected from the surface of a workpiece 16.

Alternatively, as best viewed in FIG. 2, the vision cameras may be immediately upstream of the fields of view of the profile cameras so as to scan the upper and lower surfaces of workpiece 16 for defects, thereby being supported on the same mounting bracket 20. A potential issue with this arrangement is that the radiation reflected from the surface of a workpiece 16 for the profile scanner 22a may potentially be scattered towards the sensor array corresponding to the immediately adjacent vision camera 23a. To resolve that issue, one or more radiation shields 32 may be inserted between the profile scanner 22a and vision camera 23a so as to block any scattered radiation from an adjacent scanner or camera so that the scattered radiation does not reach the corresponding sensor array. The one or more radiation shields 32 may extend substantially parallel to a field of vision 24a of the profile scanner 22a, for example, or may extend substantially orthogonal to a plane of the sensor array (not shown).

The laterally spaced apart array of S-curved chainways 14 are substantially parallel to each other in the infeed 26a into and outfeed 26b from zone 10a, respectively, and spaced apart at regular intervals thereacross. Each chainway 14 includes a plurality of roller lugs 30, the roller lugs 30 spaced apart at regular intervals along the chainway 14. As seen for example in FIG. 2, the roller lugs 30 urge the workpieces 16 in the workpiece flow direction A. The chainways 14 have an S-bend along the length of the chainway indicated by reference numeral 14a. The S-bend occurs within the scanning zone 10a and laterally offsets the section of chainway 14 in the infeed 26a as compared to the section of that same chainway 14 in the outfeed 26b. The S-bend is formed in the longitudinally extending support for the chainway and is accomplished by using chains which allow for lateral curvature; for example, without intending to be limiting, the side bow roller chains supplied by Rexnord™.

The lateral offset by the S bend 14a provides a lateral offset distance L sufficient so that the width the chainway 14, which would otherwise occlude the field of view of the first or upstream array of scanners 28a when imaging a workpiece 16, is sufficient to allow the second or downstream array of scanners 28b to find the areas of workpiece 16 within their field of view, which areas were occluded by the upstream location of chainway 14. Thus, the S-bend 14a in the chainways 14 allows the offset positioning of these scanners between the first and second arrays of scanners 28a, 28b, thereby providing, collectively, for a complete image of each workpiece 16 when the images from the first and second arrays of scanners are merged by a processer (not shown), without the need to remove parts of the images which show the transfers.

With the lateral offset L being set to the lateral thickness of chainway 14, and with the field of vision 24b of the array of upstream scanners 28a substantially abutting the field of vision 24b of the array of downstream scanners 28b, the result is that the images captured by the first and second array of scanners do not overlap when their images of a workpiece 16 are merged and thus the processor does not have any overlapping data to remove from the image. This reduces the amount of processing required for each image of each workpiece and thus improves the efficiency of the scanning system.

Advantageously, the scanners in the first array of scanners 28a, and the scanners in the second array of scanners 28b, may be inclined at an angle, for example an acute angle relative to a position orthogonal to workpieces 16, so that the scanners' corresponding fields of view 24a, 24b corresponding to scanners 22a, 22b are also inclined. For example, and without intending to be limiting, the angle of inclination of the scanners may be approximately 30 degrees from a vertical axis extending orthogonal to a plane of the upper or lower surface of workpiece 16. As is known in the prior art, the inclining of the scanners allows for the scanning of the leading and trailing edges of workpieces 16 in addition to the upper and lower surfaces of workpieces 16.

If the S-bends 14a in chainways 14 were all oriented in the same direction laterally relative to the direction of flow, the result may be that workpieces 16 may shift laterally as they cross over the S-bends. This is undesirable because then the lateral position of each workpiece 16 would become unknown depending on the amount of its lateral shift, and so the images taken by the first and second arrays of scanners 28a, 28b would not be properly imaging the adjacent and abutting sections of workpiece 16 because of the lateral shift of the workpieces. Thus, the collective image of each workpiece 16 would not be truly representative of each workpiece due to the lateral shifting. In order to inhibit such lateral shifting of the workpieces, the S-bends 14a, for example between adjacent chainways 14, either converge or diverge symmetrically, as best seen in FIG. 2. Therefore, the tendency of one S-bend 14a to shift a workpiece in one direction is countered by an adjacent S-bend which urges the shifting of the workpiece in an opposite lateral direction with a symmetric, opposing and approximately equal amount of lateral force so that the pair of symmetrically converging or diverging S-bends 14a counteract each other, and each workpiece 16 does not shift laterally as the workpiece travels between the first and second arrays of scanners.

Furthermore, dead skids 33, positioned alongside and elevated slightly above the S-bend 14a raises the workpiece 16 off the chainways 14 as the workpiece travels over the S-bend 14a. The dead skids 33, which may be manufactured of steel or ultra high molecular weight (UHMW) polymers or any other suitable materials known to a person skilled in the art, further minimize the possible lateral shifting that may otherwise occur when the workpieces travel over the S-bends 14a The friction between the weight of the workpiece 16 and the dead skid 33 will resist lateral movement because this friction is approximately equal to the force with which the roller lugs 30 are pushing the workpiece 16. Depending on the materials used to manufacture the dead skid 33, such as for example UHMW polymers or stainless steel, the frictional force between the lower surface of the workpiece 16 and the dead skid 33 is approximately the same in both the lateral and transverse directions, Therefore, the force of the roller lug acting on the workpiece in the lateral direction will be less than the frictional force between the board and the dead skid 33, thereby further reducing or preventing the lateral shifting of the workpiece 16 that may otherwise occur as it travels over the lateral curves or S-bends 14a. It will be appreciated that a stabilizing device for reducing or preventing the lateral shifting of the workpiece 16 as it travels over the S-bends 14a is not intended to be limited to the dead skids 33 described above, and that other devices may include a short chain, belt section or similar devices running alongside or parallel to, and elevated slightly above, the S-bends in the chainways 14 so as to temporarily lift the workpieces 16 off of the chainways 14 as the workpieces travel over the S-bend section 14a.

This effect of minimizing or eliminating the lateral shift of the workpiece 16 that may occur as it travels over the S-bends 14a is further facilitated by the roller lugs 30 which reduce the amount of lateral force being applied to the workpiece 16 as it passes over S-bend 14a. The use of roller lugs 30 on each chainway 14 allows for the movement of each lug along the workpiece 16 it is supporting while minimizing the lateral effect on the S bends on the lateral positon of the workpiece. The result then is that the collective image merged from the abutting, adjacent images taken of a particular workpiece by the first and second arrays of scanners are truly representative of a continuous view along the upper and lower surfaces and the leading and trailing edges of each workpiece 16.

What is claimed is:

1. A scanner system comprising:
a plurality of scanners cooperating with a corresponding plurality of radiation sources which collectively are spatially separated in both a transverse and a longitudinal direction relative to a workpiece flow in said longitudinal direction,
wherein said plurality of scanners have substantially separate, non-overlapping fields of view,
and wherein said plurality of scanners produce corresponding scanned image data for processing by image processing software,
and wherein a workpiece transport which moves workpieces in said workpiece flow includes lateral curves in said transverse direction so that said workpiece transport does not substantially occlude said fields of view,
whereby said spatial separation renders unnecessary substantially any removal by the image processing software of portions of said image data which include images of said transport mechanisms which interfere with unobstructed images of workpieces carried in said flow direction by said transport mechanisms.

2. A scanner system for scanning workpieces, the system composing:
a plurality of scanners cooperating with a corresponding plurality of radiation sources which collectively are spatially separated in both a transverse and a longitudinal direction relative to a workpiece flow in said longitudinal direction, the plurality of scanners adapted to produce corresponding scanned image data for processing by image processing software,
a transport which moves the workpieces in the workpiece flow, the transport including lateral curves in the transverse direction so that said workpiece transport does not occlude a field of view of a scanner of the plurality of scanners,
wherein a first field of view of each scanner spatially separated in the longitudinal direction from a laterally adjacent scanner having a second field of view is adjacent to and abuts against the second field of view, so that the scanned image data produced by each scanner of the plurality of scanners abuts the scanned image data produced by the laterally adjacent scanner,
whereby the scanned image data produced by each scanner of the plurality of scanners does not include overlapping image data.

3. The scanner system of claim 1 wherein the transport includes a laterally spaced array of substantially parallel transfers, wherein the transfers in the array alternatively converge and diverge between the infeed and outfeed portions of the transport so as to form symmetrically converging or diverging pairs of transfers, whereby a cumulative lateral force on a workpiece of the workpieces being carried on the pairs of transfers is substantially eliminated.

4. The scanner system of claim 3 wherein each transfer in the array of transfers is a chainway, each chainway including a plurality of roller lugs, the roller lugs spatially separated in the longitudinal direction so as to urge the workpieces along the workpiece flow.

5. The scanner system of claim 1 wherein the transport includes stabilizing devices adjacent the lateral curves, whereby the stabilizing devices temporarily support the workpieces above the lateral curves as the workpieces flow across the lateral curves in the workpiece flow so as to reduce lateral shifting of the workpieces.

6. The scanner system of claim 5 wherein the stabilizing devices are selected from a group comprising: dead skids, elevated short chains, elevated belt sections.

7. The scanner system of claim 2 wherein the field of view of each scanner is oriented at an angle relative to a vertical axis passing through a planar surface of the workpieces, whereby a leading and trailing edge of each workpiece is captured in the scanned image data.

8. The scanner system of claim 2 wherein the plurality of scanners includes an array of vision scanners and an array of profile scanners.

9. The scanner system of claim 8 wherein each spatially separated scanner of the plurality of scanners is mounted on a bracket, each bracket supporting both a vision scanner and a profile scanner.

10. The scanner system of claim 9 wherein each vision scanner and profile scanner includes a corresponding sensor array for sensing radiation reflected from the workpieces, wherein each sensor array is surrounded by one or more radiation shields, the one or more radiation shields shielding each sensor array from scattered radiation originating from a radiation source corresponding to an immediately adjacent scanner.

11. The scanner system of claim 8 wherein the plurality of scanners further includes an array of tracheid scanners.

12. A scanner system to sequentially scan a series of workpieces translating in a downstream flow direction sequentially to a first scanner scanning a first scanning zone on an infeed portion of a continuous conveyor and then to a second scanner scanning a second scanning zone on an outfeed portion of the continuous conveyor, the first and second scanning zones extending longitudinally across the infeed and outfeed portions of the continuous conveyor, wherein the infeed portion and first scanning zone is laterally offset from the outfeed portion and second scanning zone relative to the downstream flow direction of the workpieces,
wherein each scanner of the first and second scanners have corresponding first and second fields view, wherein in the second scanning zone, a downstream end of the infeed portion is laterally offset relative to an upstream end of the outfeed portion so as to thereby avoid an overlap between the first and second fields of view.

13. The scanner system of claim 12 wherein the infeed portion of the continuous conveyor is laterally offset from the outfeed portion of the continuous conveyor by means of a lateral curve in the continuous conveyor, the lateral curve positioned between the infeed and outfeed portions.

14. The scanner system of claim 13 wherein the continuous conveyor includes a laterally spaced array of substantially parallel transfers, wherein the transfers in the array alternatively converge and diverge between the infeed and outfeed portions of the continuous conveyor so as to form symmetrically converging or diverging pairs of the transfers, whereby a cumulative lateral force on a workpiece on the pairs of transfers is substantially eliminated.

15. The system of claim 14 wherein the transfers are chainways.

16. The system of claim 15 wherein the chainways include roller lugs.
